(19) United States
(12) Patent Application Publication
(10) Pub. No.: US 2025/0297843 A1
(43) Pub. Date: Sep. 25, 2025

(54) INNER DIAMETER MEASURING APPARATUS AND SYSTEM THEREOF

(71) Applicant: Tokyo Seimitsu Co., Ltd., Tokyo (JP)

(72) Inventors: Daisuke SATO, Tsuchiura-shi (JP); Kunihiro NAKANO, Tsuchiura-shi (JP); Wataru ITOYA, Tsuchiura-shi (JP)

(21) Appl. No.: 19/080,167

(22) Filed: Mar. 14, 2025

(30) Foreign Application Priority Data
Mar. 22, 2024 (JP) 2024-046244

(51) Int. Cl. G01B 3/46; B25J 19/02

(52) U.S. Cl. CPC G01B 3/46; B25J 19/02

(57) ABSTRACT

Provided is an inner diameter measuring apparatus that can obtain an accurate measurement result, while being mounted on a robot arm even in an environment in which large electromagnetic noise occurs. An inner diameter measuring apparatus is mounted on a tip part of a robot arm in a detachable manner to measure an inner diameter of a hole formed in a workpiece. The inner diameter measuring apparatus includes at least two contactors and a data conversion and transmission part. The at least two contactors are in contact with an inner wall face of the hole formed in the workpiece. The data conversion and transmission part converts analog data about displacements of the at least two contactors into digital data representing the inner diameter of the hole and transmits the digital data to an external device.

### CROSS-REFERENCE TO RELATED APPLICATION

This application claims the benefit of Japanese Application No. 2024-046244, filed Mar. 22, 2024, which are hereby incorporated by reference in their entirety.

### BACKGROUND OF THE INVENTION

### 1. Field of the Invention

The present disclosure relates to an inner diameter measuring apparatus to be mounted on a tip part of a robot in a detachable manner to measure an inner diameter of a hole formed in a workpiece and a system thereof.

### 2. Description of the Related Art

Automotive parts and the like (workpieces) are being produced using six-axis arm industrial robots, cooperative robots, and the like. Industrial robots and the like make mass production more labor-saving.

These workpieces must be accurately measured at each stage of manufacturing. For this purpose, automatic measurement using industrial robots and the like is being attempted.

When an object to be measured is an inner diameter of a workpiece, a method can be employed in which a measuring part of an inner diameter measuring apparatus mounted on a tip of an arm of an industrial robot or the like (also called a robot arm) is inserted into the object to perform measurement. In this case, if an outer diameter of the measuring part is made slightly smaller than the workpiece inner diameter, highly accurate measurement is easily achieved.

A typical measurement procedure is as follows. First, a small gap is formed between the workpiece and the measuring part, and the measuring part is inserted into the workpiece while maintaining the gap. Subsequently, for example, when the inner diameter measuring apparatus is an air micrometer, measurement is made while maintaining a minute distance between the measuring part and a workpiece inner wall. When the inner diameter measuring apparatus is of a contact type, measurement is made by pressing contactors against the workpiece inner wall at a measurement position. Examples of such workpiece inner diameter measuring apparatuses are described in Japanese Patent No. 6910668, Japanese Patent Application Laid-open No. H10-339623, and Japanese Patent No. 7238187.

In addition, Japanese Patent Application Laid-open No. 2023-142301 and Japanese Patent Application Laid-open No. 2023-142303 disclose a method for measuring the inner diameter of the workpiece by mounting an inner diameter measuring apparatus having a contact type measuring head part on the tip of the robot arm.

### SUMMARY OF THE INVENTION

Air micrometers are often used to measure the hole diameter of workpieces. This is generally due to advantages such as the availability of air sources that are often supplied in factories. In the measurement of the hole diameter (the workpiece inner diameter) using an air micrometer, the blowing reaction force of air is measured. For this reason, it is preferable to maintain the distance between an outlet and the workpiece inner wall minute. As an example, the gap between the air outlet and the workpiece inner wall can be set at 0.5 mm or less, specifically around 0.1 mm. The gap between a wall part other than the air outlet and the workpiece inner wall may be set to be smaller, sometimes at 0.01 to 0.1 mm. Note that the air outlet may be called a “nozzle,” and the wall part other than the air outlet may be called a “guide.”

As described above, the distance between the measuring part and the workpiece inner wall is minute, and precise positioning or the like is required to insert the measuring part into the workpiece. In particular, when automatic measurement is attempted to be performed using a robot, detection of the workpiece, precise positioning of a workpiece position, and positioning of the air micrometer with respect to the workpiece position are required. Furthermore, it is also necessary to teach the handling operation of the air micrometer to the robot. When the hole diameters of many (mass-produced) workpieces are attempted to be measured in sequence, the positions of the holes may vary, and besides the stopping position of the robot (the starting position of a measurement operation) may also vary each time. Thus, insertion of the measuring part into (the hole of) the workpiece itself is very difficult. In addition, if the insertion is attempted forcibly, the workpiece and/or the measuring part may be damaged due to the occurrence of “galling” described below.

Japanese Patent No. 6910668 discloses a method of overlapping the center of the hole to be measured with the center of the measuring part of the air micrometer by a floating mechanism. It is said that this enables highly accurate and quick measurement even if the positioning of the robot arm is inadequate. However, the method described in Japanese Patent No. 6910668 has a problem in that the hole is limited to be an upward one because it permits only the horizontal displacement of the workpiece, and the measurement is not general-purpose hole measurement. In addition, since the air micrometer is used, an external part for converting air pressure and flow rate to measured values is separately required, which is complicated by the requirement of space and piping needed for this purpose.

When the air micrometer is used, there is only a minute gap between the outer diameter of the measuring part and the inner wall of the hole to be measured. Thus, when the measuring part is mechanically inserted into the hole to be measured, it is necessary to take exceptional measures to inhibit collisions or “galling” from occurring between them. Japanese Patent Application Laid-open No. H10-339623 does not describe such measures.

One way to solve this problem is to teach the robot the position of the hole to be measured and then perform feedback control using a force sensor to accommodate individual differences in workpieces. In this case, the feedback control is typically performed in coordination with a PLC. However, teaching and/or control programming for coordination is likely to be complicated, and the force sensor is often expensive.

Japanese Patent No. 7238187 discloses a method of bringing a plurality of contactors into contact with the inner wall of the hole to be measured of the workpiece to measure the inner diameter of the hole to be measured. The contactors are provided in such a manner that they can be retracted inside the measuring part. In this case, the contactors are retracted inside the measuring part when inserted into the hole to be measured.

When this is achieved by the inner diameter measuring apparatus mounted on the robot arm, another problem arises. Generally, robot arms have multiple degrees of freedom, up to six degrees of freedom at the most. It is difficult to repeatedly position such a robot arm in the same hole position at all times. Speed is also required for continuous measurement of mass-produced products, but the method in Japanese Patent No. 7238187 assumes measurement performed a plurality of times. For these reasons, it is inappropriate to implement the method in Japanese Patent No. 7238187 by the robot arm.

Japanese Patent Application Laid-open No. 2023-142301 and Japanese Patent Application Laid-open No. 2023-142303 disclose a method for measuring the inner diameter of the workpiece by mounting an inner diameter measuring apparatus having a contact type measuring head part on the tip of the robot arm. The measuring unit described in each of the above documents includes a collision detector and a force sensor, and the contactor is retracted when inserted into the hole to be measured. Thus, even if the measuring head part collides with the workpiece during insertion, the contactor is protected.

However, the measuring unit is mounted on the robot arm, and thus a new problem, or electromagnetic noise, arises. Industrial robots often control their motions using servomotors or the like. In this case, electromagnetic noise derived from motors and control means is generally large. One factor is that servomotors repeatedly fine-tune their positions even when they appear to be stopped. This large electromagnetic noise may adversely affect minute detection signals detected by the measuring unit.

An object of the present disclosure is to solve at least any of the problems with the conventional technologies. A specific object is to provide an inner diameter measuring apparatus that can obtain an accurate measurement result, while being mounted on a robot arm even in an environment in which large electromagnetic noise occurs. Another specific object is to provide an inner diameter measuring system that can automatically insert a measuring part, without being damaged, into holes to be measured of many workpieces. Still another specific object is to provide an inner diameter measuring system that can automatically measure holes to be measured of workpieces of different diameters (different nominal diameters).

One embodiment of the inner diameter measuring apparatus of the present disclosure is an inner diameter measuring apparatus to be mounted on a tip part of a robot arm in a detachable manner to measure an inner diameter of a hole formed in a workpiece, the inner diameter measuring apparatus including at least two contactors and a data conversion and transmission part, the at least two contactors being in contact with an inner wall face of the hole formed in the workpiece, and the data conversion and transmission part converting analog data about displacements of the at least two contactors into digital data representing the inner diameter of the hole and transmitting the digital data to an external device.

### BRIEF DESCRIPTION OF THE DRAWINGS

FIG. 1 is a perspective view of an example of an inner diameter measuring system;

FIG. 2 is a perspective view of an example of an inner diameter measuring apparatus;

FIG. 3 is a vertical sectional view of a principal part of the inner diameter measuring apparatus illustrated in FIG. 2;

FIG. 4 is a perspective view of a principal part of another example of the inner diameter measuring apparatus; and

FIG. 5 is an illustrative diagram of a method for correcting a tilt of the inner diameter measuring apparatus illustrated in FIG. 4.

### DETAILED DESCRIPTION OF EMBODIMENTS

A first embodiment of the inner diameter measuring apparatus of the present disclosure is an inner diameter measuring apparatus to be mounted on a tip part of a robot arm in a detachable manner to measure an inner diameter of a hole formed in a workpiece, the inner diameter measuring apparatus including at least two contactors and a data conversion and transmission part, the at least two contactors being in contact with an inner wall face of the hole formed in the workpiece, and the data conversion and transmission part converting analog data about displacements of the at least two contactors into digital data representing the inner diameter of the hole and transmitting the digital data to an external device.

One of the features of the inner diameter measuring apparatus is that it includes the data conversion and transmission part. The data conversion and transmission part is provided integrally with the inner diameter measuring apparatus. The inner diameter measuring apparatus is mounted on the tip of the robot arm in a detachable manner. In other words, the inner diameter measuring apparatus is a replaceable device. This inner diameter measuring apparatus integrally includes the data conversion and transmission part converting the analog data to the digital data.

The data conversion and transmission part converts the analog data, which is raw measurement data about the displacements of the contactors, into the digital data representing the inner diameter of the hole to be measured. Furthermore, the data conversion and transmission part transmits this digital data to the external device. Examples of the external device include computers as control apparatuses for the robot arm (a robot).

As described above, large electromagnetic noise is often present near the robot arm. If such electromagnetic noise is mixed in with the data representing the inner diameter of the hole, the stability and accuracy of the measurement may be impaired. However, in the inner diameter measuring apparatus, the measurement data is externally transmitted as the digital data by the data conversion and transmission part integrally configured. The digital data is easily transmitted and received accurately even in an environment in which large electromagnetic noise is present. Thus, when the inner diameter measuring apparatus is used to automate inner diameter measurement by the robot arm, both stable measurement and acquisition of highly accurate measurement data can be achieved.

A second embodiment of the inner diameter measuring apparatus of the present disclosure is the inner diameter measuring apparatus of the first embodiment, in which the data conversion and transmission part transmits the digital data to the external device connected in a wired manner.

The data conversion and transmission part preferably transmits the digital data to the external device (e.g., a robot arm control apparatus) connected in a wired manner. In this case, power supply may be received from the external device through a similar wired connection.

A third embodiment of the inner diameter measuring apparatus of the present disclosure is the inner diameter measuring apparatus of the first embodiment, further including a plug gauge holding the at least two contactors on a tip part and a connecting part provided between the plug gauge and the data conversion and transmission part, in which the connecting part is configured to permit displacements in an axial direction of the robot arm with respect to the plug gauge and a direction substantially perpendicular to the axial direction.

One of the features of the inner diameter measuring apparatus is that it includes the connecting part. This connecting part is configured to be able to permit the displacements in the axial direction of the robot arm and the direction substantially perpendicular thereto. In the inner diameter measurement by the robot arm, the inner diameter measuring apparatus is inserted into the hole to be measured. By providing the connecting part, even if unintended contact between the workpiece and the inner diameter measuring apparatus occurs due to misalignment of the workpiece or the like during insertion, damage caused thereby is easily reduced. Examples of the damage include failure of the plug gauge and the like and/or flaws in the workpiece due to contact.

In addition, by permitting the displacement in the direction substantially perpendicular to the axial direction by the connecting part, teaching man-hours are more reduced. The teaching is done to the robot arm. By the teaching, an insertion position (the position of the hole) is memorized in advance. Even if the actual hole to be measured is positioned off that position, the deviation can be absorbed by the connecting part. Thus, even if the accuracy of the teaching is lower, insertion of the inner diameter measuring apparatus into the hole is easily smoothly executed.

A fourth embodiment of the inner diameter measuring apparatus of the present disclosure is the inner diameter measuring apparatus of the third embodiment, in which the connecting part is formed in a longitudinally columnar shape as a whole and includes a bush holder formed in an annular shape and a floating mechanism, a relieving mechanism, and a measuring mechanism held in the bush holder, the floating mechanism permits the displacement in the direction substantially perpendicular to the axial direction, the relieving mechanism permits the displacement in the axial direction, the measuring mechanism acquires the analog data, and in the bush holder, the measuring mechanism is disposed at a central part, and the floating mechanism and the relieving mechanism are disposed around the measuring mechanism.

In the inner diameter measuring apparatus having the floating mechanism and the relieving mechanisms, examples in which these mechanisms and the measuring mechanism are arranged in series are common, but the inner diameter measuring apparatus is more compact (shorter in length) than such examples. Thus, moment given to the robot arm can be reduced.

When the data conversion and transmission part is provided in the inner diameter measuring apparatus, a new problem arises in which the inner diameter measuring apparatus becomes somewhat heavier and somewhat larger. However, the inner diameter measuring apparatus provides the connecting part that serves as all the three functions to shorten the overall length and thus solves the above problem.

The three functions are specifically the floating mechanism, the relieving mechanism, and the measuring mechanism. Owing to the floating mechanism and the relieving mechanism, insertion of the inner diameter measuring apparatus into the hole is easily smoothly executed.

A fifth embodiment of the inner diameter measuring apparatus of the present disclosure is the inner diameter measuring apparatus of the fourth embodiment, in which the relieving mechanism includes at least three ball bushes disposed spaced apart from each other in a circumferential direction of the bush holder and bush shafts provided for the respective ball bushes and passing through central parts of the ball bushes.

A sixth embodiment of the inner diameter measuring apparatus of the present disclosure is the inner diameter measuring apparatus of the fourth embodiment, in which the floating mechanism includes an elastic body, and one end of the elastic body is locked to the bush holder.

A seventh embodiment of the inner diameter measuring apparatus of the present disclosure is the inner diameter measuring apparatus of the first embodiment, in which the at least two contactors are four contactors, the inner diameter measuring apparatus includes displacement measuring devices connected to the four respective contactors, the four contactors are disposed spaced apart from each other in a circumferential direction, and the data conversion and transmission part converts the analog data detected by the displacement measuring devices into digital data representing the inner diameter of the hole and transmits the digital data to the external device.

The inner diameter measuring apparatus enables more accurate inner diameter measurement. Since it includes the four contactors, it is particularly useful when the axis of the inner diameter measuring apparatus and the axis of the hole are not parallel (when they are tilted). Based on the displacement amounts of the four contactors, a tilt θ of the inner diameter measuring apparatus can be calculated more accurately. The positions of the four contactors are not limited to particular positions, but two sets of contactors are each preferably disposed at opposite positions (180-degree intervals) in the circumferential direction of the inner diameter measuring apparatus. The disposition between the two sets of contactors is not limited to particular disposition, but the four contactors are preferably disposed at 90-degree intervals in the circumferential direction.

A first embodiment of the inner diameter measuring system of the present disclosure is an inner diameter measuring system including the robot arm and the inner diameter measuring apparatus according to any of the first to seventh embodiments.

The inner diameter measuring system can achieve both stable measurement and highly accurate measurement data acquisition through the configuration and functions of the inner diameter measuring apparatus described above.

The following describes examples of the inner diameter measuring apparatus and the inner diameter measuring system including the same using the drawings. In mass-produced products such as automotive parts and home appliances, the inner diameters of holes to be measured of workpieces of different diameters (of different varieties and of different nominal diameters) may be measured. Due to a reduction in a tact time in manufacturing and the like, measurement is made unattended and highly efficient by using robots.

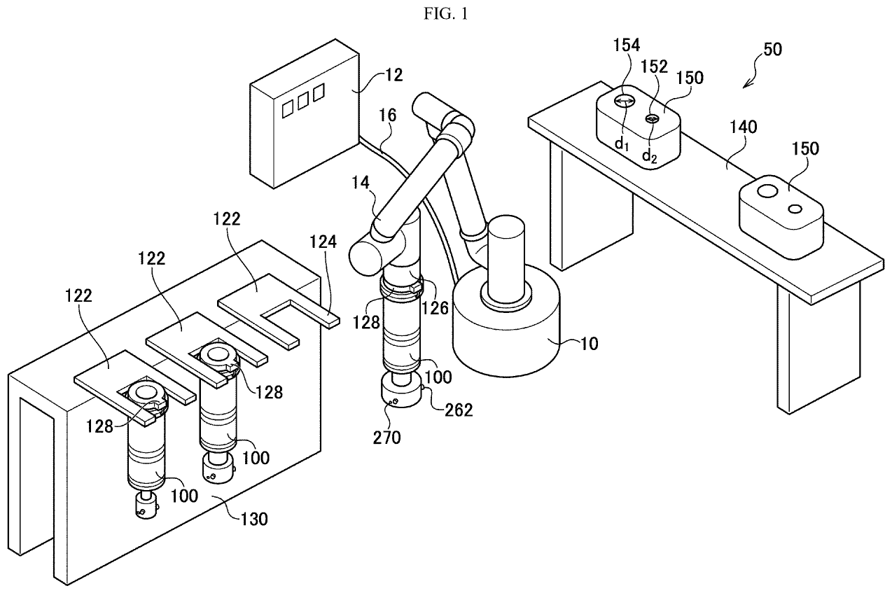

FIG. 1 is a perspective view of an example of an inner diameter measuring system 50 including an inner diameter measuring apparatus 100.

The inner diameter measuring system 50 performs unattended measurement of a hole to be measured of a workpiece using a robot 10.

The inner diameter measuring system 50 includes a conveyor 140, the robot 10, and a tool table 130.

The conveyor 140 continuously brings in workpieces 150 that have been subjected to processing such as drilling. Instead of the conveyor 140, the inner diameter measuring system 50 may include a measuring table.

The workpiece 150, which is an object to be measured, is formed with a plurality of holes 152 and 154 of different diameters. The workpiece 150 waits on the conveyor 140 for the measurement of the holes 152 and 154.

The inner diameter measuring system 50 also includes the tool table 130. A plurality of tool holders 122 are fixed to the tool table 130. The tool holders 122 hold the respective inner diameter measuring apparatuses 100, 100, . . . of different outer diameters (nominal diameters). One inner diameter measuring apparatus 100 out of them is in use.

The inner diameter measuring apparatus 100 in use has been taken out of the tool holder 122 at the right end of the tool table 130. The inner diameter measuring apparatuses 100, 100, . . . can be interchangeably mounted on the tip of a robot arm 14. This enables measurement of the holes 152 and 154 of different inner diameters formed in the workpiece 150.

The automatic robot 10 is disposed between the tool table 130 and the conveyor 140. The automatic robot 10 is a multi-joint, multi-degree-of-freedom robot that can operate in an unattended manner.

On the tip of the robot arm 14, the inner diameter measuring apparatus 100 held by the tool holder 122 is mounted. The robot 10 is connected to a robot controller 12 via wiring 16 (via wired connection). The actions of the robot 10 are preprogrammed, and all measurement-related actions are executed automatically or in an unattended manner. Note that typically, the robot controller 12 is preferably a computer including a processor and memory. The robot controller 12, which is a computer, loads a program stored in the memory, executes it by the processor, and can thereby control various parts of the inner diameter measuring system.

The robot 10 rotates each joint to move the tip part of the robot arm 14 to any position and angle. This movement first brings the robot arm 14 close to the upper face part of the inner diameter measuring apparatus 100 held by the tool holder 122. Next, the tip part of the robot arm 14 is translated from the tip (opening) side of a guide part 124 of the tool holder 122. Next, a tool side changer 128 and a robot arm side changer 126 are engaged and secured with each other, and the inner diameter measuring apparatus 100 is integrated with the robot arm 14. The state in which the robot arm side changer 126 and the tool side changer 128 are integrated is referred to as a robot hand changer.

The method for separating the robot hand changer into the tool side changer 128 and the robot arm side changer 126 is as follows. First, the inner diameter measuring apparatus is housed in the tool holder 122 with the robot arm 14 and the inner diameter measuring apparatus 100 integrated. In this state, a stopper, not shown, provided in the robot hand changer is released. This release is performed by a command from the robot controller 12.

The above procedure automates mounting of the inner diameter measuring apparatus 100 on the robot arm 14, replacement of the inner diameter measuring apparatus 100, and removal of the inner diameter measuring apparatus 100.

The robot 10 first measures holes of the same nominal diameter for workpieces 150 the number of which is designated by the robot controller 12. Next, the inner diameter measuring apparatus 100 is replaced to measure holes of a different nominal diameter. By disposing a plurality of robots 10 and mounting the inner diameter measuring apparatuses 100 of different nominal diameters on the respective robots 10, the measurement is made more efficient.

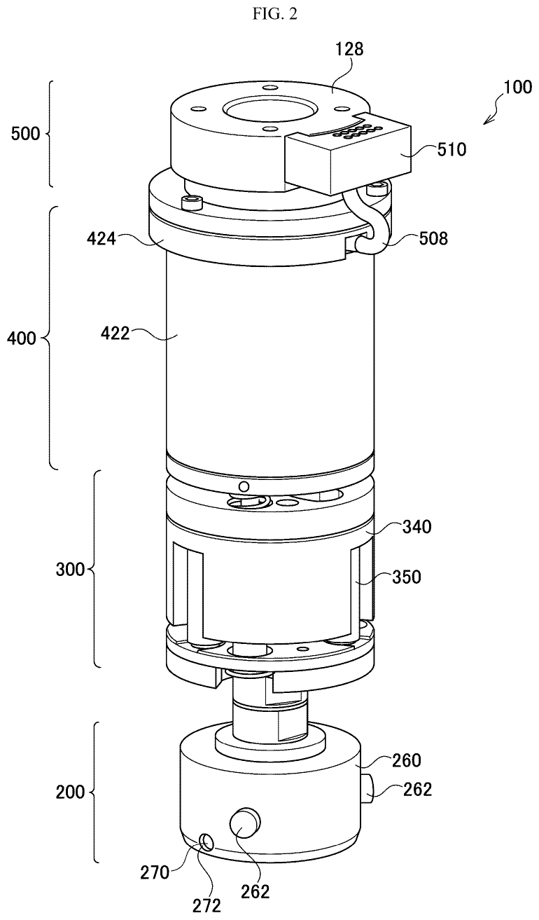

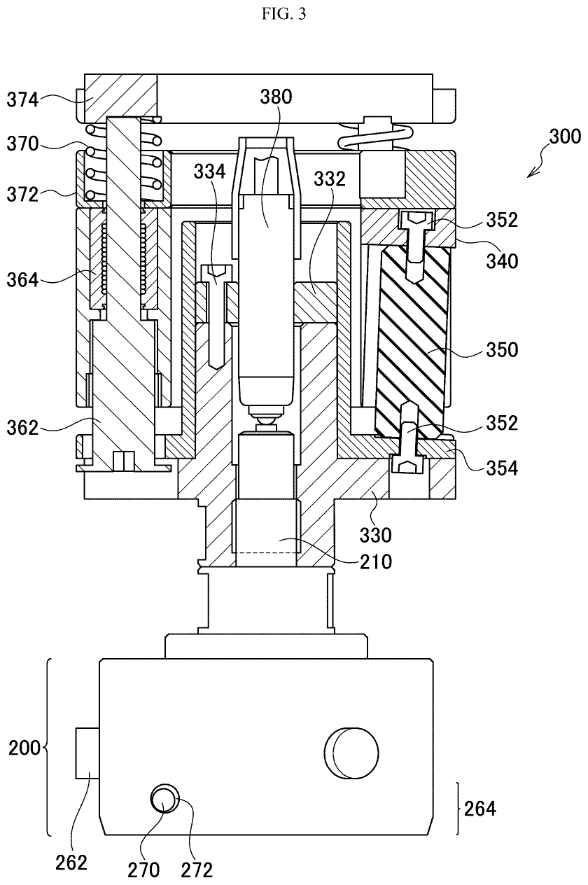

Next, an example of the inner diameter measuring apparatus 100 will be described using FIG. 2 and FIG. 3. FIG. 2 is a perspective view of the inner diameter measuring apparatus 100. As illustrated in FIG. 2, the inner diameter measuring apparatus 100 broadly includes a plug gauge 200, a floating and relieving part 300, a data conversion and transmission part 400, and a robot hand changer part 500.

The plug gauge 200 is inserted into the holes 152 and 154 formed in the workpiece 150. The plug gauge 200 includes a cylindrical plug gauge body 260, a plurality of stoppers 262, and at least two contactor holes 272. The stoppers 262 and the contactor holes 272 are disposed substantially equally spaced from each other in the circumferential direction. The contactor holes 272 each include a contactor 270 being in contact with the holes 152 or 154.

The floating and relieving part 300 is positioned above the plug gauge 200 and permits and corrects the misalignment of the plug gauge 200. The floating and relieving part 300 further detects the displacement of the contactor 270 by a built-in measuring device 380. The floating and relieving part 300 includes an elastic body 350 for floating. The elastic body 350 for floating is mounted on a cylindrical bush holder 340.

The data conversion and transmission part 400 is positioned above the floating and relieving part 300. The data conversion and transmission part 400 is covered with a cylindrical body cover 422 and has a flange 424 at its top. The data conversion and transmission part 400 converts analog data about the displacement of the contactor 270 into digital data representing the inner diameters of the holes 152 and 154. The analog data about the displacement of the contactor is acquired by the measuring device 380 (refer to FIG. 3). The data conversion and transmission part 400 transmits the digital data representing the inner diameters to the robot controller 12 (corresponding to the external device). The measuring device 380 is built into the floating and relieving part 300. In the environment in which the robot arm 14 is driven, electromagnetic noise makes accurate transmission and reception of analog data difficult. In the present example, however, the data conversion and transmission part 400 is positioned directly above the measuring device 380, and thus the distance and time for analog data transmission are minimal. In addition, the data conversion and transmission part 400 transmits the data to the external device as the digital data, which is resistant to electromagnetic noise, thus enabling more accurate and stable measurement.

For the plug gauge 200, a commercially available plug gauge is used, and the BMD plug gauge manufactured by DIATEST, Germany, is used, for example. The plug gauge 200 is formed with through holes at a plurality of sites on the side face of the cylinder. These through holes are the contactor holes 272.

The contactor 270 is inserted through this contactor hole 272. The contactor 270 is movable in the radial direction of the cylinder. The radial displacement amount of the contactor 270 is converted to a vertical displacement amount of a built-in needle. The needle is disposed on the back side of the contactor 270 (the central side of the plug gauge 200), extending in the vertical direction. The needle is tapered.

Force is applied to the contactor 270 to push it outward in the radial direction of the cylinder at all times. This force is obtained by utilizing the elasticity of the needle. Thus, the contactor 270 protrudes from the outer peripheral face of the plug gauge 200 by about 0.1 to 0.2 mm at all times in a normal condition.

Inside the floating and relieving part 300, the measuring device 380 is disposed. The measuring device 380 is connected to the needle of the plug gauge 200 or is disposed above a plug gauge shaft 210, which is integral with the needle.

With this, the displacement of the needle will be input to the measuring device 380. A displacement signal from the measuring device 380 is transmitted to the data conversion and transmission part 400. As the measuring device 380, a working transformer type displacement meter can be used. Apart from the working transformer type displacement meter, an optical scale type displacement meter using a laser beam, an air micrometer, and the like can also be used as the measuring device 380.

The measuring device 380 is disposed at the center of the floating and relieving part 300, which is formed in a columnar shape. Three relieving shafts 362 are disposed concentric with the measuring device 380 around the outer periphery of the measuring device 380. The relieving shafts 362 extend in the vertical direction spaced apart from each other in the circumferential direction. In the present example, there are three, but there may be three or more relieving shafts 362. A ball bush 364 is intervened on the vertical middle of the relieving shaft 362. A spring 370 is also intervened on the relieving shaft 362. The lower end face of the spring 370 is in contact with the upper end face of the ball bush 364.

The ball bush 364 is held in each of three vertical through holes. The vertical through holes are formed at circumferential positions of the cylindrical bush holder 340, the positions corresponding to the relieving shafts 362. In the present example, there are three vertical through holes, but the number of them can be changed in accordance with the number of the relieving shafts 362.

The bush holder 340 extends in the vertical direction downward beyond the lower end of the ball bush 364. The relieving shafts 362 are loosely fit in the holes beyond the lower end of the ball bush 364. On the upper face of the bush holder 340, at least three ring-shaped spring holding plates 372 formed with through holes passing through in the vertical direction are disposed. The spring 370 is loosely fit in this through hole with the lower end part of the spring 370 held. To hold the upper end part of the spring 370, a ring-shaped pressing plate 374 is disposed spaced apart from the spring holding plate 372 in the vertical direction. The upper end part of the relieving shaft 362 is fixed to the pressing plate 374. The gap between the spring holding plate 372 and the pressing plate 374 is 4 to 5 mm. The pressing plate 374 is connected to a bottom flange of the data conversion and transmission part 400.

An outer cylindrical holder 354 is disposed between the cylindrical ball bush 364 and the measuring device 380. The outer cylindrical holder 354 has a cylindrical shape having a flange at its lower side. The upper end of the outer cylindrical holder 354 extends slightly below the upper end of the ball bush 364. An inner cylindrical holder 330 is fit inside the outer cylindrical holder 354. The inner cylindrical holder 330 has a cylindrical shape formed with a flange in the axial middle. A pressing plate 332 is mounted on the upper face part of the inner cylindrical holder 330 with a fastening screw 334. The flange part of the outer cylindrical holder 354 is placed on the upper face of the flange in the axial middle of the inner cylindrical holder 330. The inner cylindrical holder (a plug gauge holder) 330 holds an output shaft of the plug gauge 200 at its lower part.

The bush holder 340 is formed with a plurality of notches for mounting the elastic body 350 for floating. The notches are formed at positions other than the circumferential positions in which the holes for the relieving shafts 362 are formed. The notches are formed to extend in the vertical direction at a plurality of circumferential sites. The elastic body 350 for floating is mounted on this notch with screws 352 and 352.

That is, the notches are formed at a plurality of circumferential sites on the bush holder 340. The elastic body 350 for floating the size corresponding to this notch is mounted. The upper end of the elastic body 350 for floating is mounted on the bush holder 340. The lower end thereof is mounted on the flange part of the outer cylindrical holder 354. Installation in all the cases is by means of the screw 352. The elastic body 350 for floating has elasticity and is rectangular parallelepiped, columnar, or cylindrical. The material thereof may be rubber, plastic, or combinations thereof. The elastic body 350 for floating may be a coil spring. The material thereof may be metal, reinforced plastic, or the like.

The operation of the thus configured floating and relieving part 300 configured will be described. First, the inner diameter measuring apparatus 100 is mounted on the tip of the robot arm 14. Next, the robot 10 causes the robot arm 14 to approach the workpiece 150 having the holes 152 and 154 in a preprogrammed manner. Next, the plug gauge 200 of the inner diameter measuring apparatus 100 is positioned above the holes 152 and 154 in accordance with the program. Next, the plug gauge 200 is lowered into the holes 152 and 154.

At this time, the centers of the holes 152 and 154 formed in the workpiece 150 and the center of the plug gauge 200 differ within a tolerance. The columnar part of the plug gauge 200 below the stoppers 262 acts as a guide part 264 when the plug gauge 200 is inserted into the holes 152 and 154. The gap (clearance) formed by the outer diameter of the guide part 264 of the plug gauge 200 and the inner diameters of the holes 152 and 154 is typically a few tens of micrometers. Thus, the guide part 264 is lowered while bringing its part into contact with the inner walls of the holes 152 and 154. At this time, if the force by the guide part 264 pushing the walls of the holes 152 and 154 increases due to misalignment or when the guide part 264 is inserted inclined and if only part of the guide part 264, such as a corner part, comes into contact with the walls, large pressure is applied to the contact point. Given these circumstances, when the pressing force during contact due to misalignment is large, problems such as the galling of the guide part 264 with the holes 152 and 154 may occur, and this has been an obstacle to automatic measurement.

Given this, in the present example, a plurality of elastic bodies 350 for floating are provided in the bush holder 340. The elastic body 350 for floating, in accordance with contact force when the guide part 264 comes into contact with the inner walls of the holes 152 and 154, automatically displaces or moves the plug gauge 200 in a direction that reduces the contact force. The elastic body 350 for floating can elastically become deformed in the left and right direction on the plane of FIG. 3. Thus, even if the plug gauge 200 is inserted into the holes 152 and 154 with the center thereof deviating from the centers of the holes 152 and 154 in the left and right direction (or tilted with respect to the vertical axis), the plug gauge 200 and the inner cylindrical holder 330 will tilt to follow the holes 152 and 154. This is due to the elastic deformation of the elastic body 350 for floating. As a result, the center of the plug gauge 200 matches the centers of the holes 152 and 154. As a result, the plug gage 200 can be inserted to deeper measurement positions in the holes 152 and 154.

The misalignment of the plug gage 200 with respect to the holes 152 and 154 generally has a component perpendicular to the vertical direction. In other words, the misalignment has a component in the left and right direction on the plane of FIG. 3. In still other words, when the vertical direction is a z direction, the misalignment has x and y components perpendicular thereto. Thus, one or more elastic bodies 350 for floating corresponding to the misalignment in the x and y directions are disposed in the circumferential direction of the bush holder 340. There is no limitation on the direction of deformation of the elastic body 350 for floating, and a single elastic body 350 for floating can accommodate the misalignment in the x and y directions. On the other hand, when three or more elastic bodies 350 for floating are disposed in the circumferential direction, it becomes easier to change the positions of the bush holder 340 and the outer cylindrical holder 354 and the inner cylindrical holder 330 while keeping them near parallel. At least three fixed points are required to determine a plane. In the form in which three or more elastic bodies 350 for floating are disposed in the circumferential direction, rotation about the x and y axes is more restricted, which enables more accurate misalignment correction. The disposition of the elastic bodies 350 for floating is not limited to particular disposition, but they are preferably equally spaced from each other in the circumferential direction. For example, if three are disposed, about 120° intervals are preferred.

As described above, in the floating and relieving part 300, which is the connecting part, the elastic bodies 350 for floating, the bush holder 340, and the inner cylindrical holder 330 form the floating mechanism.

The ball bushes 364 are intervened on the three relieving shafts 362. The three relieving shafts 362 are disposed at different circumferential positions from the elastic bodies 350 for floating. That is, the ball bushes 364 are disposed at different circumferential positions from the elastic bodies 350 for floating. The ball bush 364 is displaceable in the vertical direction along the relieving shaft 362. When excessive force is applied to the inner cylinder holder 330, the bush holder 340 moves up and down, causing the plug gauge 200 to move up and down. The excessive force occurs, for example, when the guide part 264 of the plug gauge 200 comes into contact with the inner faces of the holes 152 and 154. The vertical movement of the bush holder 340 is achieved by the spring force of the spring 370. The vertical movement of the bush holder 340 occurs via the outer cylindrical holder 354, which is placed on the inner cylindrical holder 330. This relieves the plug gauge 200. The relieving shafts, at least three ball bushes 364, and the spring 370 constitute the relieving mechanism.

The floating and relieving part 300 (the connecting part) includes the relieving mechanism, the floating mechanism, and the measuring device 380. The floating and relieving part 300 is an integrated component with the measuring device 380 disposed at its central part and the floating mechanism and the relieving mechanism disposed around the measuring device 380. Through the integration, the axial length (the vertical length) of the floating and relieving part 300 is made shorter and made more compact than conventional ones. This can reduce a moment load applied to the robot arm 14. This is particularly advantageous when the inner diameter measuring apparatus 100 is mounted on the tip part of the robot arm 14 and moved to a measurement position. Being made compact makes it more suitable for storage on the tool table 130. It also makes tool changing work easier.

The following describes a method for measuring the inner diameters of the holes 152 and 154 of the workpiece 150 using the inner diameter measuring apparatus 100.

First, the inner diameter measuring apparatus 100 corresponding to the hole diameters of the holes 152 and 154 is mounted on the tip of the robot arm 14. Selection of the inner diameter measuring apparatus 100 from the tool table 130 and mounting of it are performed automatically by the robot 10.

Next, the inner diameter measuring apparatus 100 is calibrated using a master, not shown. The robot 10 turns and translates the robot arm 14 to the vicinity of the workpiece 150 that has been brought in to a certain position on the conveyor 140. Next, the plug gauge 200 of the inner diameter measuring apparatus 100 is positioned above the holes 152 and 154.

Next, the robot 10 slowly inserts the inner diameter measuring apparatus 100 into the holes 152 and 154 using the guide part 264 of the plug gauge 200 as a guide. In that process, the guide part 264 and the holes 152 and 154 have a misalignment within a tolerance. The misalignment between the plug gauge 200 and the holes 152 and 154 is eliminated by the floating mechanism. That is, the floating mechanism displaces the floating and relieving part 300 to self-align the plug gauge 200 with the holes 152 and 154.

Next, the plug gauge 200 is lowered to a position in which the stoppers 262 act or to a measurement depth position set in advance.

Next, measurement is started at this position, and the displacement amounts of the contactors 270 are transmitted to the measuring device 380 as mechanical deformation. The measuring device 380 converts the deformation (the displacement) to an electric signal (analog data). The data conversion and transmission part 400 converts the electric signal (the analog data) representing the displacement amounts converted and acquired by the measuring device 380 into digital data representing the inner diameters of the holes 152 and 154. The digital data is transmitted to the robot 10 via a data cable 508 and an electrode apparatus 510. The digital data is finally stored in the robot controller 12 or a storage attached thereto.

Force is applied to the contactor 270 to push it outward from the contactor hole 272 of the plug gauge 200 at all times. When the plug gage 200 is not in contact with another object (a normal state), the contactor 270 protrudes from the plug gage 200 by about 0.2 mm due to the pushing force. The contactor 270 has a hemispherical tip shape. Thus, even if it comes into contact with the inner wall faces of the holes 152 and 154 while protruding by about 0.2 mm, it is pulled inside the plug gauge against the pushing force following the inner wall faces without causing galling or the like due to the lowering force of the plug gauge 200.

In some cases, the lowering operation of the plug gauge 200 may be stopped midway and pulled up. Examples of such a case include a case in which the holes 152 and 154 formed in the workpiece 150 are formed outside a tolerance due to faulty machining and a case in which the hole positions are out of an expected range. Such an operation can be performed using the relieving mechanism of the floating and relieving part 300. However, the function that the relieving mechanism has is the function of passively shrinking due to excessive external force. Thus, there are limitations on the case when the pulling up is achieved. For example, there is a method utilizing the fact that the force for the relieving mechanism to operate is stronger than a normal insertion operation. That is, there is a method that sets pulling up if the robot detects an abnormal load (to the extent that the relieving mechanism operates) during the insertion operation.

Next, tool replacement will be described. The tool replacement is done, for example, for each batch if it is batch processing. When workpieces continuously carried on a conveyor or the like are continuously measured, for example, the tool replacement is done for each certain number of workpieces. For each certain number of workpieces, the holes 152 and 154 of the workpiece 150 are changed. Specifically, when the hole 152 of a small diameter is first measured for a certain number of workpieces 150, and then the hole 154 of a large diameter is measured, the tool replacement is performed at the time of switching.

In the tool table 130, the inner diameter measuring apparatuses 100 with different measurable ranges are housed in the tool holders 122.

First, the inner diameter measuring apparatus 100 corresponding to the hole 152 of a small diameter is mounted on the tip of the robot arm 14. Mounting is performed automatically by the robot 10 having received a command from the robot controller 12. Next, the inner diameter of the hole 152 of a certain number of workpieces 150 is measured.

Next, the robot arm 14 is turned and translated to be guided to a vacant tool holder 122. Next, a stopper, not shown, is released to separate the robot arm side changer 126 and the tool side changer 128 from each other. In this state, only the robot arm side changer 126 is mounted on the tip of the robot arm 14. Next, the robot arm 14 is moved to be positioned on a certain tool holder 122. This tool holder 122 houses the inner diameter measuring apparatus 100 corresponding to the hole 154 to be measured of a large diameter. Next, a new inner diameter measuring apparatus 100 is mounted on the tip of the robot arm 14, enabling measurement of the hole 154 to be measured of a large diameter.

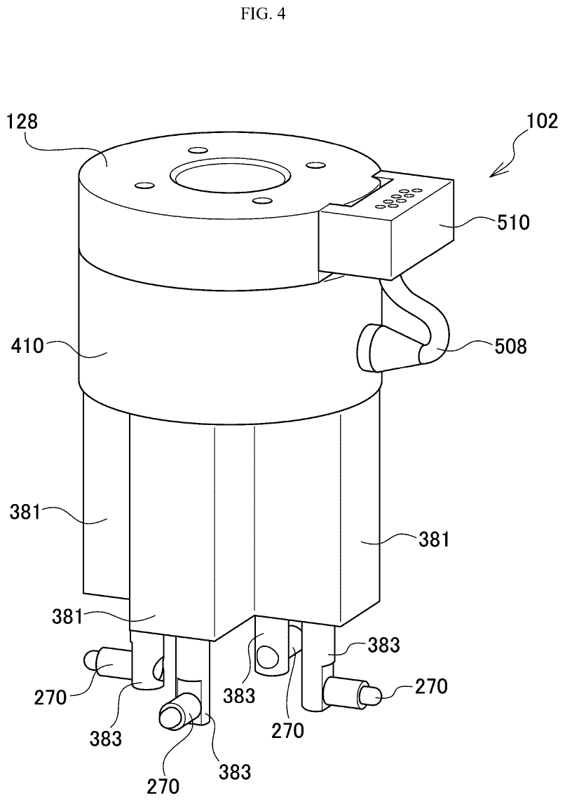

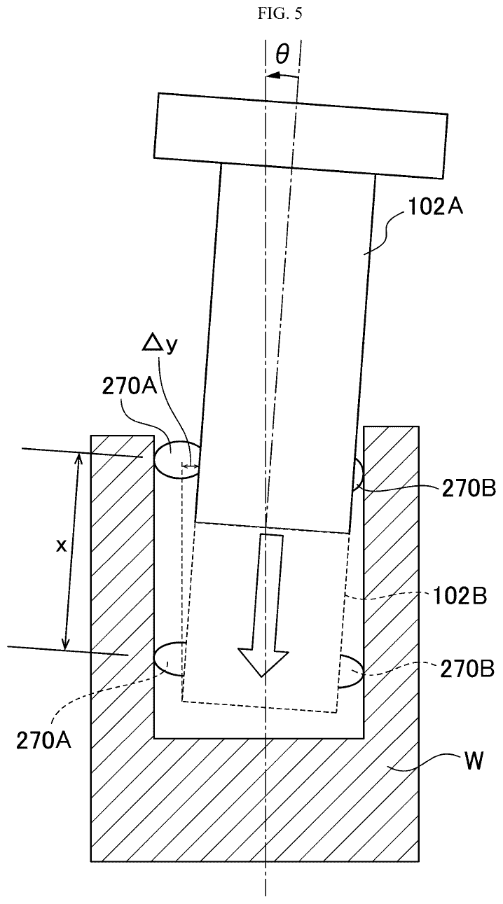

Next, another example of the inner diameter measuring apparatus will be described. FIG. 4 is a perspective view of a principal part of the other example of the inner diameter measuring apparatus. FIG. 5 is an illustrative diagram of a method for correcting a tilt of the inner diameter measuring apparatus illustrated in FIG. 4.

This inner diameter measuring apparatus 102 illustrated in FIG. 4 differs from that of the above example mainly in the following two points. The first is that the plug gauge and the connecting part are integrated, further simplifying the configuration. The other is to correct the misalignment of the inner diameter measuring apparatus 102 (the contactors 270) with respect to the holes 152 and 154. This is due to, for example, the fact that four (or more, as the case may be) contactors 270 are provided.

The inner diameter measuring apparatus 102 includes a combination of two sets of displacement measuring devices as described in, for example, Japanese Patent Application Laid-open No. 2018-169180. This data conversion and transmission part 410 has the same configuration as in the example described above. Four displacement measuring devices 381 are connected to the data conversion and transmission part 410. The displacement measuring device 381 is, for example, a linear variable differential transformer (LVDT) or an optical scale type displacement meter.

Fingers 383 extending in the vertical direction are disposed at the lower end part of the displacement measuring devices 381.

The contactors 270 for displacement measurement are mounted on the respective fingers 383.

Outward force is applied to each of the contactors 270 at all times. The outward force is applied by an elastic body via the finger 383. In a normal condition, the radius of an envelope circle connecting the tips of the contactors 270 is about 0.1 to 0.5 mm larger than the maximum diameter of the inner radius of the hole to be measured. This enables measurement even when variations in the inner radius within about its tolerance and the occurrence of misalignment are taken into account.

The tip part of the contactor 270 is hemispherical. When the inner diameter measuring apparatus 102 is inserted into the holes 152 and 154, the hemispherical part of the contactor 270 comes into contact with the inner faces of the holes 152 and 154. Note that a (retracting) function of forcibly moving and retracting the fingers 383 of the displacement measuring devices 381 inward in the radial direction by several millimeters by built-in cylinders or the like, not shown, may be included. Being inserted into the hole in a retracted state produces an effect of not hitting the hole and not damaging the workpiece by minor misalignment of the hole or faulty machining.

The following describes a method for measuring the inner diameters of the holes 152 and 154 using the inner diameter measuring apparatus 102, including a method of correction in FIG. 5.

First, the inner diameter measuring apparatus 102 is calibrated in advance using a master. At that time, the center of the master and the center of the inner diameter measuring apparatus are centered. During centering, the output (calibration data) of the displacement measuring device 381 is obtained from the displacement of each of the contactors 270.

Next, the inner diameter measuring apparatus 102 is inserted into the hole 152 of the workpiece 150. During insertion, the central axis of the inner diameter measuring apparatus 102 may be inserted tilted with respect to the central axes of the holes 152 and 154.

FIG. 5 is an illustrative diagram representing a relation between the hole 152 and an inserted inner diameter measuring apparatus 102A. FIG. 5 illustrates how the central axis of the inner diameter measuring apparatus 102A is inserted tilted with respect to the central axis of the hole 152. The inner diameter measuring apparatus 102A, which is indicated by the solid line in FIG. 5, shows a state in which it is shallowly inserted into the hole 152. The inner diameter measuring apparatus 102B, which is indicated by the broken line, shows a state in which it is inserted more deeply into the hole 152.

As is clear from the comparison between the inner diameter measuring apparatus 102A and the inner diameter measuring apparatus 102B, the retraction amount (the displacement amount) of each of the contactors varies depending on the depth of insertion. The contactor 270A is pushed inward as the inner diameter measuring apparatus is inserted into hole 152. The contactor 270B is pushed outward as the inner diameter measuring apparatus is inserted into the hole 152. For more accurate inner diameter measurement, it is preferable to correct a measured value in accordance with the tilt θ.

The tilt θ is unknown at the beginning of insertion. To correct the measured value, the tilt θ is first calculated. The method is as follows.

First, the tilt θ of the inner diameter measuring apparatus 102 is determined based on the following expression from an insertion amount x and a change Δy in the measured value in a cross section including the contactors and the central axis of the inner diameter measuring apparatus. (Expression) θ=tan⁻¹(Δy/x)

The change Δy in the measured value is typically caused by the tilt of the inner diameter measuring apparatus. However, the change Δy in principle also occurs by causes other than the tilt of the inner diameter measuring apparatus. Examples of the causes include a case in which the holes 152 and 154 are formed in a tapered shape and a case in which the inner diameters of the holes 152 and 154 vary in the depth direction.

To distinguish between these and the change due to the tilt of the inner diameter measuring apparatus, it is preferable to determine the tilt θ from the average of the outputs of a pair of contactors 270A and 270B disposed with a phase difference of 180° with each other.

Once the tilt θ is calculated in this manner, the robot 10 rotates the inner diameter measuring apparatus 102 so as to cancel the tilt θ. This aligns the central axes of the holes 152 and 154 and the central axis of the inner diameter measuring apparatus 102 with each other.

Now that the inner diameter measuring apparatus 102 can be inserted along the central axes of the holes 152 and 154, the inner diameter measuring apparatus 102 is inserted to a certain measurement depth. Next, the displacement amounts (analog data) of the four contactors 270 are transmitted to the displacement measuring devices 381. The data conversion and transmission part 400 converts the displacement amounts into digital data representing the inner diameters and transmits the digital data to the robot controller.

According to the present example, the positioning accuracy of the inner diameter measuring apparatus 102 by the robot 10 can be rough. Thus, man-hours required for teaching can be reduced. Furthermore, by aligning the centers of the master and the inner diameter measuring apparatus 102 with each other during mastering (zero-point alignment) of the inner diameter measuring apparatus 102, the inner diameters and the center positions of the holes 152 and 154 can be obtained from a comparison with calibration using the master during inner diameter measurement of the holes 152 and 154 formed in the workpiece 150. The center positions of the holes 152 and 154 can be used as a measurement result of the workpiece 150 or for position correction for teaching of the robot 10. In addition, the movable displacement of the contactors 270 can be increased, and thus the frequency of replacement of the inner diameter measuring apparatus 102 can be reduced. In an aspect, the movable displacement can be increased up to a maximum of 0.5 to 2 mm.

In each of the above examples, the distance from the measurement by the contactors to the data conversion and transmission part is made as short as possible, and thus adverse effects on measurement due to noise caused by industrial robots, especially servomotors used for them can be reduced. In addition, the data is converted to the digital data at the stage prior to data transmission to the outside, and thus data degradation due to noise around robots can be inhibited to improve noise immunity.

The inner diameter measuring apparatus of the present embodiment includes the data conversion and transmission part that converts the detection signal detected by the contactors to the digital data, and thus even if electromagnetic noise (noise) occurs in the robot arm on which the inner diameter measuring apparatus is mounted and its surroundings, the detection signal can be securely preserved, and measurement data can be obtained. The inner diameter measuring apparatus employs the floating mechanism that permits the lateral displacement of the measuring part, and thus even if the measuring part deviates from the hole to be measured in terms of the center or the angle from the horizontal direction, it can be smoothly inserted, and the occurrence of damage and flaws in the contactors and the hole to be measured can be inhibited. Furthermore, the inner diameter measuring apparatus includes an upper end part structure corresponding to an automatic tool changer, and thus inner diameter measurement of holes of different diameters is enabled by preparing inner diameter measuring apparatuses with different measurement ranges. Furthermore, three types of mechanisms including the relieving mechanism, the floating mechanism, and the measuring mechanism are formed consolidated into the inner diameter measuring apparatus, and thus an inner diameter measuring apparatus for robots with a short overall length (vertical length) can be achieved, and a moment load at the arm end in the turning of the robot arm can be reduced.

The present disclosure solves at least any of the problems that the conventional technologies have.

What is claimed is:

1. An inner diameter measuring apparatus to be mounted on a tip part of a robot arm in a detachable manner to measure an inner diameter of a hole formed in a workpiece, the inner diameter measuring apparatus comprising:
at least two contactors; and
a data conversion and transmission part,
the at least two contactors being in contact with an inner wall face of the hole formed in the workpiece, and
the data conversion and transmission part configured to convert analog data about displacements of the at least two contactors into digital data representing the inner diameter of the hole and transmit the digital data to an external device.

2. The inner diameter measuring apparatus according to claim 1, wherein the data conversion and transmission part transmits the digital data to the external device connected in a wired manner.

3. The inner diameter measuring apparatus according to claim 1, further comprising:
a plug gauge holding the at least two contactors on a tip part; and
a connecting part provided between the plug gauge and the data conversion and transmission part, wherein
the connecting part is configured to permit displacements in an axial direction of the robot arm with respect to the plug gauge and a direction substantially perpendicular to the axial direction.

4. The inner diameter measuring apparatus according to claim 3, wherein
the connecting part is formed in a longitudinally columnar shape as a whole and includes a bush holder formed in an annular shape and a floating mechanism, a relieving mechanism, and a measuring mechanism held in the bush holder,
the floating mechanism permits the displacement in the direction substantially perpendicular to the axial direction,
the relieving mechanism permits the displacement in the axial direction,
the measuring mechanism acquires the analog data, and
in the bush holder, the measuring mechanism is disposed at a central part, and the floating mechanism and the relieving mechanism are disposed around the measuring mechanism.

5. The inner diameter measuring apparatus according to claim 4, wherein the relieving mechanism includes:
at least three ball bushes disposed spaced apart from each other in a circumferential direction of the bush holder; and
bush shafts provided for the respective ball bushes and passing through central parts of the ball bushes.

6. The inner diameter measuring apparatus according to claim 4, wherein the floating mechanism includes an elastic body, and one end of the elastic body is locked to the bush holder.

7. The inner diameter measuring apparatus according to claim 1, wherein
the at least two contactors are four contactors,
the inner diameter measuring apparatus includes displacement measuring devices connected to the four respective contactors,
the four contactors are disposed spaced apart from each other in a circumferential direction, and
the data conversion and transmission part converts the analog data detected by the displacement measuring devices into digital data representing the inner diameter of the hole and transmits the digital data to the external device.

8. An inner diameter measuring system comprising:
a robot arm; and
the inner diameter measuring apparatus according to claim 1.

9. An inner diameter measuring system comprising:
a robot arm; and
the inner diameter measuring apparatus according to claim 2.

10. An inner diameter measuring system comprising:
a robot arm; and
the inner diameter measuring apparatus according to claim 3.

11. An inner diameter measuring system comprising:
a robot arm; and
the inner diameter measuring apparatus according to claim 4.

12. An inner diameter measuring system comprising:
a robot arm; and
the inner diameter measuring apparatus according to claim 5.

13. An inner diameter measuring system comprising:
a robot arm; and
the inner diameter measuring apparatus according to claim 6.

14. An inner diameter measuring system comprising:
a robot arm; and
the inner diameter measuring apparatus according to claim 7.
